(19) United States
(12) Patent Application Publication
(10) Pub. No.: US 2009/0080665 A1
(43) Pub. Date: Mar. 26, 2009

(54) Method of Generating Secure Codes for a Randomized Scrambling Scheme for the Protection of Unprotected Transient Information

(75) Inventor: Pankaj Patel, San Jose, CA (US)

Correspondence Address: BLAKELY SOKOLOFF TAYLOR & ZAFMAN LLP, 1279 OAKMEAD PARKWAY, SUNNYVALE, CA, 94085-4040, US

(73) Assignee: ACEURITY, INC., Fremont, CA (US)

(21) Appl. No.: 11/861,120

(22) Filed: Sep. 25, 2007

(51) Int. Cl. H04K 1/04

(52) U.S. Cl. 380/287

(57) ABSTRACT

In many instances it is necessary to store and transfer information and data on a temporary basis. Typically this information and data is transient but is vulnerable to capture and piracy as it is not in an encrypted state. Therefore a unique method is disclosed that performs randomized scrambling of unprotected digital information that make it unreadable, or otherwise unusable, without the appropriate descrambling. In order to be effective and secure the method requires a large population of scrambling patterns, or codes, and assigns them index numbers. Scrambling patterns are randomly chosen for use in the scrambling of the information and data. Unique schemes for developing this large population of patterns and choosing at random the usable set at each interval or usage. In particular the method is useful in the protection of digital content.

### BACKGROUND OF THE INVENTION

1. Field of the Invention

The invention generally relates to the generation of a large number of patterns and more specifically to the generation of a large number of patterns for the use as scrambling patterns, and further more specifically for the random selection of scrambling patterns from the large number of patterns generated for use as scrambling patterns.

2. Prior Art

Information, such as the data of digital content, is known to be susceptible to piracy and unauthorized use. Many times such data is captured at points of vulnerability of the system and then reused without permission by those who rightfully own the rights to that data. Typically the problem is one of short term access to digital content data and code during usage, when it is exposed to the outside on, for example, a local bus or in a temporary storage, without security coverage by an encryption schemes. This problem of open access to such information for unauthorized tapping, holds good for content, data and software, during temporary storage, during processing, as well as transfer between subsystems, is well understood by the individuals practicing the art.

FIG. 1A shows a temporary executable code 101, storage in a controller system 100 of the type where the executable code for the controller 102 is stored in the dynamic random access memory or static random access memory (DRAM/SRAM) 103 with no protection during use. This code is liable to be accessed and stolen. The other blocks 104, 105 and 106 are subsystem blocks of the processor like non-volatile memory, analog to digital converter (ADC), digital to analog converter (DAC), or input/output (I/O) driver block.

Present real time content transmit-receive systems use complex encryption/decryption schemes, like advanced encryption system (AES) and high-bandwidth digital content protection (HDCP) to provide security and protect the content from piracy. These encryption and decryption schemes introduce latency, increase the need for storage and reduce the performance of the system. In addition, today's methods still lack full protection coverage and are vulnerable to piracy at multiple points in the processing scheme.

FIG. 1B shows the block diagram of a content receiver. An example of the problem of lack of security for content that is temporarily in storage during process is explained using FIG. 1B. At the receiver 110 the compressed and AES encrypted data/content is received and decrypted using the AES decryption algorithm in (AES_D) block 111. The extracted compressed data is temporarily stored in the temporary memory 112. It is extracted from the memory and the AES_D block 111 passes this output to the decoder. The output of this block is de-compressed and converted back to the content stream in the decoder 113 that consists of entropy decoding, Inverse Quantization and Inverse discrete cosine transform (DCT) or Inverse discrete wavelet transform (DWT). During decode the recovered frames again have to be temporarily stored in external process memory 114, typically either double data rate (DDR2) memory or synchronous dynamic random access memory (SDRAM) through the memory bus 117. This is necessary to reconstruct the following frames by adding the motion change to the previous stored frames. This frame storage is of the raw content, that is, data with clock information in frame format and is not in a protected state. The data at this stage in the process is available for copying as frames. A typical frame of 1080p/4:4:4/8 bit will require storage of approximately 6 MB (megabyte). This content is then retrieved from the temporary storage memory through the bus 117 and re-encrypted using HDCP encryption scheme in the encryption module 115, and transferred over High definition multi-media interface (HDMI) connection 116 to the display.

Current efforts at improving security during temporary storage is focused on integrating the temporary storage memory into the chip to eliminate the external tapping capability. Since the high definition (HD) frames, such as 1920×1080, require more than 6.2 MB/frame, huge amounts of memory have to be embedded on chip to achieve this. This will make the chips more expensive to manufacture, low yielding and hence non-viable.

Another area where the content is temporarily unprotected is shown in FIG. 1C. FIG. 1C is a typical block diagram of a content display or display system 120 showing the video data path. Once the HDCP/HDMI content is received by the display converter system 120 through the HDMI input 116, it is decrypted using the HDCP decryption algorithm in the decryption module 121 and decompressed and processed in the data/clock extraction module 122 and output as parallel data stream. This extracted parallel data and clock information is re-converted to suitable serial streams of low voltage differential signal (LVDS) in the LVDS encoder module 123. This serial LVDS stream is connected to the display module 130, typically comprising a serial to parallel converter 131, a frame processing block 132 such as frame multiplier, used for generating 120 Hz frames from 30 Hz frames, to generate interpolated frames where three additional frames are generated using 2 original frames by complex video processing techniques of frame interpolation with motion, blur, response time and color correction processing and digital to analog converter 133, row and column drivers 134 and TV display screen 135, through LVDS or other screen/panel interface connectors 124. The LVDS encoder module 123 output is again in the unprotected state in the LVDS link 124 and can be easily accessed for providing pirated copy of the original content.

The points in the content transmit-receive system, where high quality digital content is available for un-authorized tapping are the temporary storage into memory of the frames during processing in a receiver system and the transmission of the processed content from the receiver to the display using LVDS link 124. At all other exposed points in the Transmit-receive system the content is encrypted/coded by either AES or HDCP. At these two locations, raw content regenerated from the incoming stream is unprotected and is available to be tapped and extracted easily.

Typical randomized generation of patterns use a fixed seed to start the random number generator. It is always possible, given the time to identify the pattern of generation and hence over time defeat the protection provided. In view of this limitation it is necessary to have a much more robust and changing method of randomization oriented at providing better and stronger protection to content. That is what has been proposed in the current disclosure.

An additional problem of adding standard encryption using currently available schemes is the delay and processing power needed to handle the encryption-decryption process at the interface. It would therefore be advantageous to have a fast and easy alternative method for handling the security of the content, data and code in locations where security is lacking. It would be further advantageous if such a solution can be used without introducing any clock delay, and further be implemented using known multiplexing and de-multiplexing circuits by merely adding a few gate delays.

### BRIEF DESCRIPTION OF THE DRAWINGS

FIG. 1A is a typical block diagram of a processor with code storage in DRAM block.

FIG. 1B is a typical block diagram of prior art content receiver system.

FIG. 1C is a typical block diagram of prior art content display system.

FIG. 2 shows the possible number of permutations for each group of elements, typically bits.

FIG. 3 shows an example of forming index of different arrangements.

FIG. 4 is a method of generating and randomly selecting the scrambling pattern or code to be used with the associated index.

FIG. 5 shows examples of mode based selection of Index groups.

FIG. 6 shows the transformation of an 8 bit data on a bus scrambled using bitsecure scheme of FIG. 2.

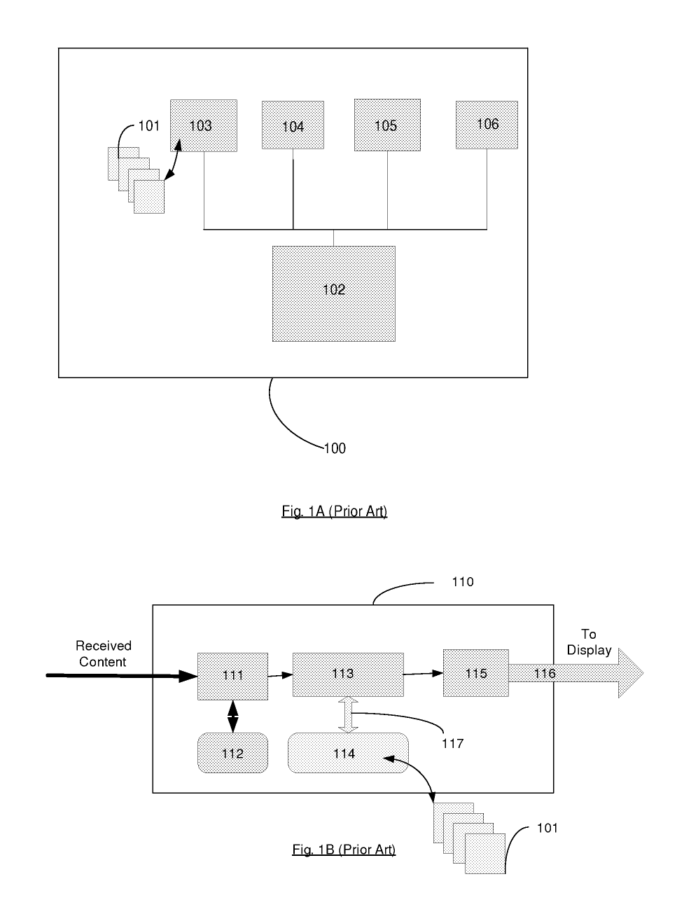

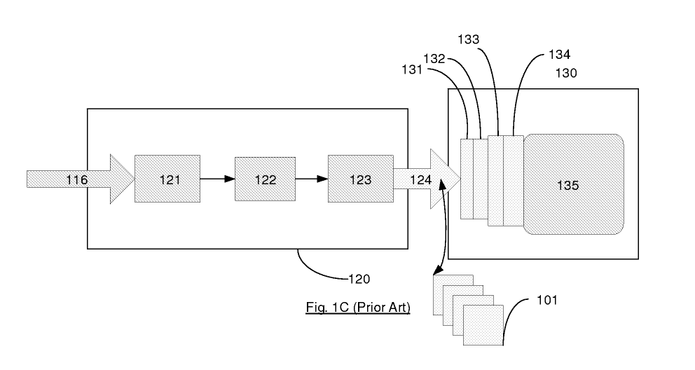

### DETAILED DESCRIPTION OF THE PREFERRED EMBODIMENTS

This application is related to a co-pending patent application entitled “A Method for Protection of Digital Rights at Points of Vulnerability in Real Time”, assigned to common assignee and is hereby incorporated by reference for all the useful information it may contain.

In many instances it is necessary to store and transfer information and data on a temporary basis. Typically this information and data is transient but is vulnerable to capture and piracy as it is not in an encrypted state. Therefore a unique method is disclosed that performs randomized scrambling of unprotected digital information that make it unreadable, or otherwise unusable, without the appropriate descrambling. In order to be effective and secure the method requires a large population of scrambling patterns, or codes, and assigns them index numbers. Scrambling patterns are randomly chosen for use in the scrambling of the information and data. Unique schemes for developing this large population of patterns and choosing at random the usable set at each interval or usage. In particular the method is useful in the protection of digital content.

In a system implementing the disclosed method, bits are scrambled using scrambling code, randomly selected from a large population of generated codes, referred to hereinafter as the Bitsecure method. The Bitsecure method, or scheme, can be used to protect digital content, data and software. The disclosed method is ideally suited to protect information and code from being accessed wherever it is available to the outside, typically on a temporary/transient basis. This eliminates the need for the temporary or transient information to be secured by encryption and compression schemes with the added delays and processing associated with same. The areas covered by the Bitsecure scheme include, but are not limited to, data securing during processing, and local transmission within a system. The Bitsecure scheme can be further used to protect executable code during operation while stored in memory in an unprotected state.

The Bitsecure scheme, disclosed herein below in greater detail, is a simple method to provide the necessary protection to the transient content, data and code, using a bit scrambling scheme. In a typical content transmit-receive system the Bitsecure scheme can be used while the content or data is sent to temporary storage during processing. It can also be used during the transmission of data and content between subsystems, like the receiver and the display. In a typical display system this is done using low voltage differential signal (LVDS) linkage. Use of the Bitsecure scheme will make any tapped or pirated content or data non-coherent and non-usable. Similarly the Bitsecure scheme can be used to protect the executable code stored in external memory during controller operation.

The method of enabling the protection of the content using the Bitsecure scheme is covered under a co-pending application “A Method for Protection of Digital Rights at Points of Vulnerability in Real Time”, assigned to common assignee, and included herein by reference for all the useful information it contains. The co-pending disclosure provides examples of the use of this bit scrambling by the Bitsecure scheme for content and data protection. This is done simply by choice, in a random mode of an index that defines the scrambling pattern for use and storing that index value till the data that is scrambled has been recovered once the processing is complete. As will be evident to a person conversant with security applications, in order to be effective in protecting the data and code using the Bitsecure scheme, it is necessary to provide a large population of scrambling codes or patterns to choose from. It is also necessary to ensure that a choice of patterns is made from the large population based on non-predictive random factors. This will make the pattern essentially impossible, or otherwise impractical, to extract and the data or content impossible, or otherwise impractical, to recover without knowing the scrambling pattern used.

What is disclosed are unique ways of generating large number of patterns for scrambling of the data/content present, for example, on a system's bus, and making the necessary random choice of the scrambling pattern to use for scrambling/descrambling the data. The chosen and used pattern itself is stored with an associated index and data identifier for retrieval for descrambling, during the temporary period the scrambled data is in existence in memory or on a local bus. The use of randomized choice of the used scrambling pattern, from a large available scrambling pattern population, make it impossible, or otherwise impractical, to reconstruct the content stream without the correct index that leads to the pattern that has been used for scrambling the bits.

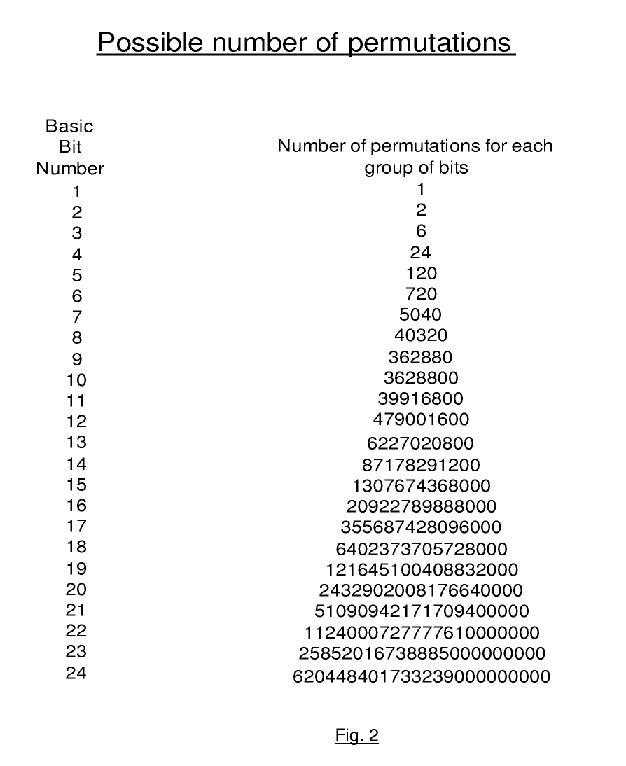

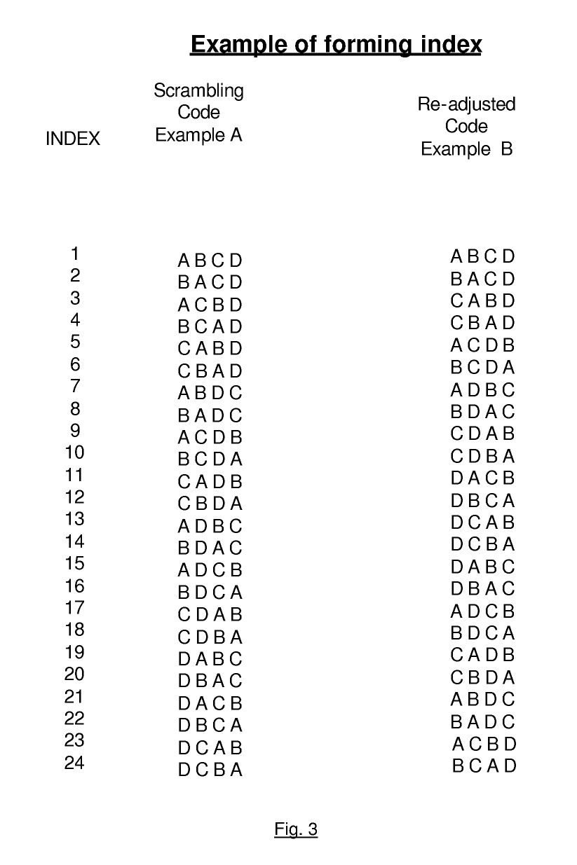

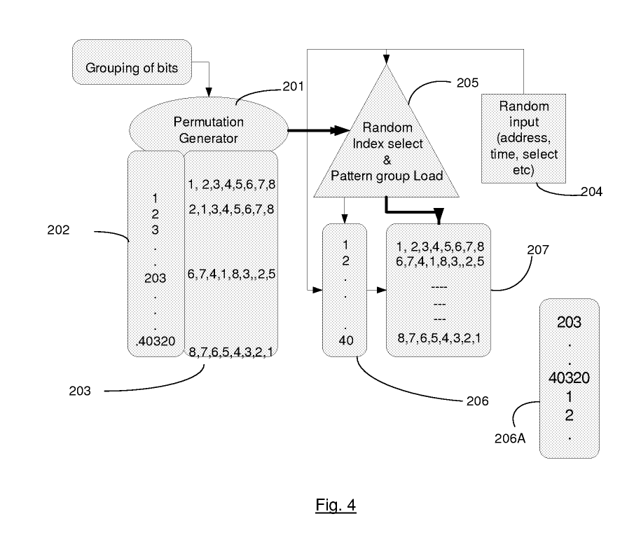

A typical process for generating the large number of patterns and choosing one or a few for use is as follows. The first step in the process is to divide the parallel bus into groups of equal bits such that the bus is divided into an integer number of groups typically of equal number of bits. The group may be of any bit width suitable for scrambling. For example a 64 bit bus can be divided typically into 16 groups of 4 bits, or 8 groups of 8 bits, or 4 groups of 16 bits, or 2 groups of 32 bits, or 1 group of 64 bits. A 4 bit grouping can produce 24 permutations while an 8 bit grouping will provide over 40K permutations and a 16 bit grouping can produce a 20×10¹² permutations. FIG. 2 shows the growth of permutations with use of larger and larger number of bits chosen as a group for scrambling. A 4 bit grouping providing 24 permutations is shown in FIG. 3. Also shown is an alternate or re-adjusted arrangement of the permutations available there by changing the index of the scrambling patterns or codes. Hence a proper choice of bit grouping can be used to provide a suitably large number of permutations of bit patterns. In a typical implementation 8 bit grouping is more than enough to create the number of patterns and index to make the security acceptable. In a case where very high security is needed the number of bits chosen in a group can be 16 or even 32 bits providing a very large group of possible patterns. The ability to re-adjust the scrambling codes based on scrambling or randomizing of index, as shown in example of re-adjusted index in FIG. 3, can be used to provide different index number choices for the same codes at various instantiations, making even a much larger number of options for indexing the patterns. This, by eliminating assignment of a fixed index to a specific pattern will prevent un-authorized extraction of the index and hence the scrambling code.

It is also possible to optionally use a reversible functions like an exclusive OR (XOR) to operate on the patterns prior to or after scrambling, thereby increasing the difficulty of unauthorized pattern identification.

Typically a smaller set of these possible patterns are randomly chosen to create the table of groupings with their index as a lookup table. This can be done conforming to some specified mode format, if so desired, rather than at random. Three exemplary and non-limiting mode based arrangements, for a 4 bit grouping, are shown in FIG. 5.

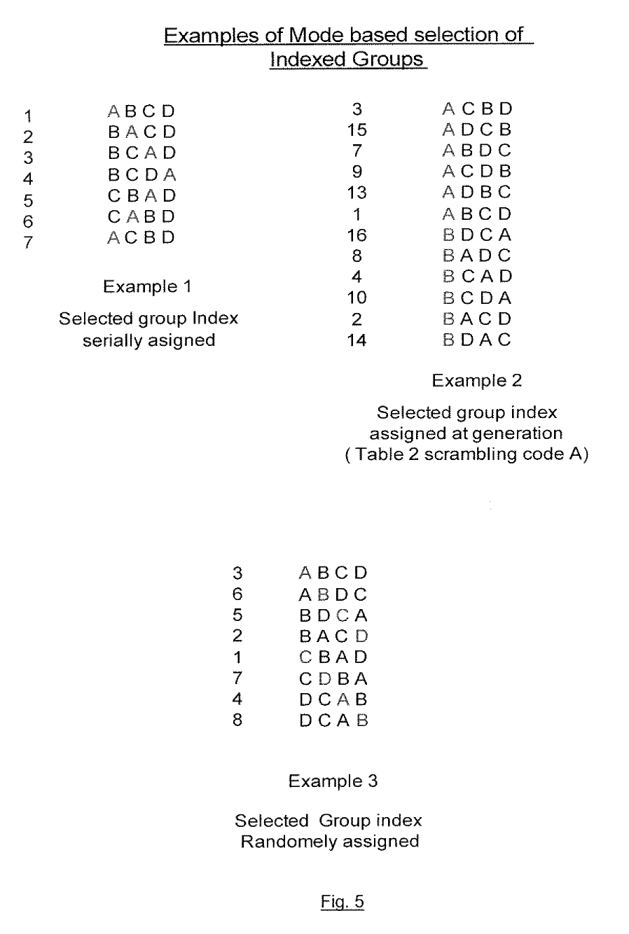

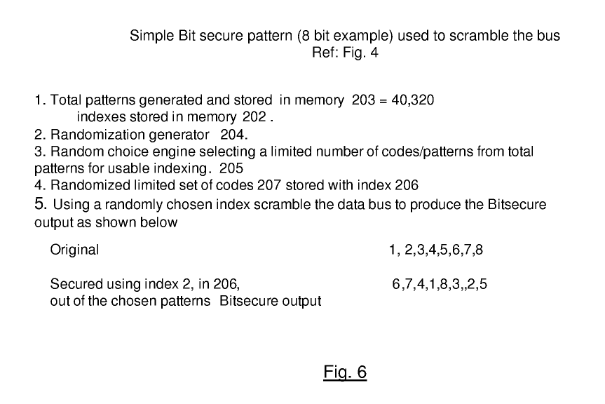

FIG. 4 shows a typical method of generating and storing the scrambling pattern or scrambling code table for use. The total set of patterns are generated and stored in a memory 203 by a pattern generator 201, taking the group bit size that is assigned. The pattern generator also assigns index numbers to the generated patterns which are also stored 202. It is possible to scramble the pattern assigned to the index numbers to achieve a much larger set of patterns and index number combinations from which to choose a usable set. It is possible to use the generated index numbers for the group of chosen scrambling patterns as shown in FIG. 4-206A. Alternately reassign the index numbers of the chosen group in a serial fashion as in 206, It can also have further randomization starting from a random scrambling pattern in the group. An example of this is shown in FIG. 3. Example 1 is all generated patterns with one assignment of index numbers and Example 2 is a second reassigned set of all generated patterns with different index to pattern assignment. This reassignment can be done each time the unit is switched on, based on a completely randomized pattern choosing block 205, without a fixed starting seed, that select the group of patterns to be used at random from the total number of patterns generated. These selected patterns can be stored in a memory 207 and used for enabling the scrambling in cases where the security is to be established. It is also possible to use random incidents like change in the high order address or chip select etc as shown in FIG. 4, 204 to act as seed for enabling or re-enabling choice of the scrambling patterns for storage in the memory 207. Index associated with the chosen patterns are also stored in the memory 206 for use during scrambling and descrambling application as described later.

FIG. 5 shows some of the ways the scrambling pattern and the index numbers can be associated after selection of sub group of patterns for use. Example 1 is a serial assignment of index to pattern within a chosen group. Example 2 shows the impact of keeping the generated assigned index numbers within a chosen usable group. Example 3 shows assigning the indexes in a random fashion within a chosen sub-group each time the sub-group is renewed.

Scrambling of a group of N bits is readily achieved using standard multiplexing techniques using 1 to N multiplexers to controllably change any bit position on the bus to any other bit position within the same group of bits. Such multiplexers comprise series of gates, and thus impose gate delays on the data, but not clock delays. Descrambling is the inverse process, using N to 1 demultiplexers. If in scrambling, bit position n is scrambled to bit position m, then descrambling is achieved by descrambling bit position m to bit position n.

FIG. 6 shows a simple scrambling transformation using the bitsecure scheme where by the bits on an 8 bit bus are scrambled. Alternately for very high security needs, the selection of the set of scrambling codes/patterns with index can be done during processing of the data/content stream, based on random input features, like the chip select of the ram to be loaded, the initial address of the content to be transferred, and/or the first byte of the content, or a combination of these. These chosen patterns with index are stored in the pattern table for use. Similarly the starting index within the pattern group can also be randomly chosen for use during each implementation of the Bitsecure scheme. In a temporary storage situation where the scrambled data is stored in a memory, the index used is stored in a latch, with the chip-select and address information for use. The chosen pattern is used to create the bit scrambling prior to transferring the information out to the memory in the location chosen by the chip-select and the address. A pattern index can be used with each frame, or a set of frames and then changed, each time storing its address with the index. It is also possible to use the same pattern and index for multiple frames using timing or other discriminating conditions. The pattern change can also be optimally based on randomizing events such as a change in the chip-select causing a change in selection of memory block enabled or appearance of a chosen address bit as input etc. Any time a selected pattern is changed based on criteria chosen, the new index is stored in a different latch. The old index is kept and used till all the frames that were temporarily stored using that scrambling pattern have been brought back and de-scrambled in the decoder. This way a continuity of the pattern recovery through the stored index is maintained. A typical selection and use of the indexed scrambling patterns for an 8 bit byte is shown in FIG. 6.

Though bit scrambling using the Bitsecure scheme is mentioned and described for protection of the content stream and data, as the application of this large pattern generation capability, it does not in any way prevent or limit the use of this for scrambling of other applications that may be apparent to practitioners of such art. In the example shown only one group of bits are used in developing the bit scrambling table, but it does not prevent increasing the complexity by using groups of bits rather than single bit as a scrambling base. In such a case the bits inside the group is scrambled independently and then the groups of bits themselves are also scrambled using a different scrambling pattern using the same Bitsecure scheme to achieve good security.

It is possible to use the large pattern base for the Bitsecure scheme as discussed above to improve the security of all transient, or temporary or short term storage application needs. This enable improved security of data or content. By providing a non-predictable randomization scheme, bit scrambling by the Bitsecure method, using a large scrambling pattern set, the possibility of code breakage is made infinitesimally small. This scheme, when implemented, provides a solution that is close to being one that replicates the ultimate scratch pad security implementation.

The above typical and non-limiting scheme, which provides the principle of bit scrambling or flipping, is a unique idea that is being disclosed for improving the security of temporary code storage, and content storage during process and local transport of data and content in a system or subsystem.

Even though this exemplary method of developing the large number of patterns easily, and further selecting a few for use in scrambling the data have been shown, it should not be thought to be a limitation of the disclosed invention. There are a number of modifications and changes that can be implemented to generate the patterns and choose one or more of them for use in a randomized fashion without departing from the disclosures made hereinabove. These will be well understood by those in the industry associated with data manipulation and protection schemes and are covered by the current disclosure.

What is claimed is:

1. A method for generating of a large number of scrambling patterns for data bits on a multibit bus in a data communication link comprising:
dividing the bits on the bus into a integer number of groups of bits, each group having the same number of bits N;
generating a plurality of unique patterns of N bits; and
assigning unique index numbers to each of said patterns;
using the patterns generated as scrambling patterns for each group of data bits on the multibit bus.

2. The method of claim 1 wherein the patterns used as scrambling patterns are selected by selecting an index and using the pattern associated with that index.

3. The method in claim 1, further enabling, at each application of power to the data communication link, assignment of the generated patterns to different index numbers, randomly, to provide a larger number of possible choices of combination of index numbers and pattern assigned, to prevent direct linkage between index and pattern leading to possible unauthorized pattern extraction.

4. The method in claim 1, wherein the number of data bits in a group is chosen to be large enough to have the plurality of unique patterns comprise a large enough number of patterns sufficient to prevent unauthorized pattern identification leading to pirating of content and data.

5. A method of generating permutations and randomly choosing a sub-set of the permutations for scrambling data bits on a multibit bus in a data communication link comprising:
selecting a grouping of bits on a bus;
generating all the unique patterns possible using the selected grouping of bits;
assigning index numbers to the generated patterns;
randomly selecting a sub-set of the index numbers and associated generated patterns;
such that the patterns chosen are non-predictable when used to scramble the data bits on the bus.

6. The method in claim 5, further comprising re-arrangement of the generated patterns to different index numbers, serially starting at a random pattern, to provide a larger number of possible choices of combination of index numbers and pattern assigned.

7. The method in claim 5, wherein the selecting of the sub-set of index numbers and associated generated patterns is chosen at random without a fixed seed for the random choice.

8. The method in claim 5, wherein the unpredictable nature of the chosen pattern used for scrambling the bits prevent pirating of data and content.

9. A method of securing data in transit using random pattern scrambling and retrieval, without incurring any clock delays comprising:
selecting a grouping of bits on a bus;
generating all the permutations possible using the selected grouping of bits;
assigning index numbers to the generated patterns; and
randomly selecting a sub-set of the index numbers and associated generated patterns for use;
using one of the sub-sets of the scrambling patterns to scramble the bits using multiplexing techniques;
storing or transferring the scrambled bits; and
using the inverse of the scrambling pattern for de-scrambling the bits using multiplexing techniques;
whereby the data experiences only gate delays in the multiplexing circuits.

10. The method of securing data in claim 9, wherein no clock delay is introduced by the multiplexing circuits used for scrambling and de-scrambling of bits.

11. A method of generating permutations and randomly choosing a sub-set of the permutations for scrambling data bits on a multibit bus in a data communication link comprising:
selecting a grouping of bits on a bus;
generating all the unique patterns possible using the selected grouping of bits;
randomly selecting a sub-set of the index numbers and associated generated patterns;
assigning index numbers to the sub-set of generated patterns;
such that the patterns selected are non-predictable when used to scramble the data bits on the bus.

12. The method in claim 11, further comprising re-arrangement of the generated patterns to different index numbers, serially starting at a random pattern, to provide a larger number of possible choices of combination of index numbers and pattern assigned.

13. The method in claim 11, wherein the selecting of the sub-set of the generated patterns is chosen at random without a fixed seed for the random choice.

14. The method in claim 11, wherein the unpredictable nature of the chosen pattern used for scrambling the bits prevent pirating of data and content.
